(19) United States
(12) Patent Application Publication
(10) Pub. No.: US 2006/0292525 A1
(43) Pub. Date: Dec. 28, 2006

(54) Duncan's Implant Sleeve

(76) Inventor: Gary Allan Duncan, Dublin, OH (US)

Correspondence Address: GARY ALLAN DUNCAN, 8831 LOCHERBIE COURT, DUBLIN, OH, 43017, US

(21) Appl. No.: 11/433,894

(22) Filed: Sep. 6, 2006

Related U.S. Application Data
(60) Provisional application No. 60/680,864, filed on May 16, 2005.

(51) Int. Cl. A61C 13/225

(52) U.S. Cl. 433/177

(57) ABSTRACT

The Duncan Implant Sleeve is to retain dentures to already existing implant Hader bars in patient's mouths. The Hader bars have now a system, where as, there is a small clip that is manufactured and sold to retain dentures. This clip has many imperfections. It is therefore the claim of Gary Allan Duncan, the inventor of the Duncan Implant Sleeve, that this utility does remedy these imperfections as listed in the specification.

Purpose

The Duncan Implant Sleeve is to retain dentures to already existing implant Hader bars in patient's mouths. The Hader bars have now a system, where as, there is a small clip that is manufactured and sold to retain dentures. This clip has many imperfections. It is hereby the claim of Gary Allan Duncan that the Duncan Implant Sleeve is the remedy to these imperfections by the flowing comparisons and advantages:

1. The sleeve covers the entire implant, not just in a few areas like the clip.

2. The sleeve can utilize as much retention from the implant that the patient would like, in order to hold their denture in place, and the clip sold does not.

3. The sleeve goes to place one way and is very easy to place in the mouth, compared to the clip. This is the major problem with the clips, where the clip can bend over because the placement of their denture was just right. When the clip bends then, the patient needs to go to the dentist and lab for new clips.

4. The sleeve is made of acetyl, which is a flexible material and will last 3-4 times longer than a clip.

Procedures and Materials:

Steps for fabricating the Duncan Implant Sleeve:
1. From the dentist, a model of the patients Hader bar is sent to the lab.
2. The Hader bar model is placed on a surveyor to eliminate all undercuts with wax.
3. The technician cuts away the wax to create how much retention is required.
4. The model with wax is now duplicated by using a material that copies the model.
5. Stone is poured into the duplication process.
6. Once the stone hardens, this becomes our new working model.
7. A sheet of thin wax is applied to the whole area of the Hader bar on the new model.
8. This model with the thin layer of wax is now placed into a injection type denture flask by using stone.
9. Sprues to the area of the thin wax is created.
10. The flask is placed into boiling water to eliminate all wax.
11. The flask is placed n the injection machine to inject the acetyl material , which replaces the thin layer of wax.
12. The injected piece is broken out of the mould and is trimmed to perfection.
13. The sleeve is made and is ready to be placed in the denture in order to retain and stabilize the denture to the Hader bar.

What is claimed by Gary Allan Duncan for the Duncan Dental Implant Sleeve:

1. The Duncan Implant Sleeve is a dental device that will retain implantable dentures to all already existing and all newly manufactured dental implant bar(s).

2. The device defined in claim 1 will remedy all imperfections of methods that use clips to retain dentures to dental implant bar(s).

3. The device defined in claim 1 will cover the entire dental implant bar(s), and use said retention to hold the denture in place in a dental patient's mouth.

4. The device defined in claim 3 can be made to accommodate any desired level of said retention.

5. The device defined in claim 1 can only be placed in the mouth one way and will be easy to place in a patient's mouth unlike other methods that use clips to retain dentures to dental implant bar(s).

6. The device defined in claim 5 can be easily removed from denture appliance.

7. The device defined in claim 4 can be later adjusted if needed according to dental patient's desire.

8. The device defined in claim 1 will be made custom to fit each individual implant bar(s).

9. The device defined in claim 1 will last longer than any other bar type retainers.

10. The device defined in claim 1 is lightweight.

11. The device defined in claim 1 is made of ADA approved material.

12. Nothing will bond to the device defined in claim 1.
